(19) United States
(12) Patent Application Publication
(10) Pub. No.: US 2023/0125948 A1
(43) Pub. Date: Apr. 27, 2023

(54) WELDING DEVICE AND METHOD OF MANUFACTURE

(71) Applicant: BWXT Canada Ltd., Cambridge (CA)

(72) Inventors: Casey Brendan Linn, Puslinch (CA); Justin Thomas Mosterd, Kitchener (CA); Manley Joseph Tyler Fraleigh, Dresden (CA)

(21) Appl. No.: 17/970,838

(22) Filed: Oct. 21, 2022

Related U.S. Application Data
(60) Provisional application No. 63/270,167, filed on Oct. 21, 2021.

(51) Int. Cl. B23K 9/16; B23K 9/28

(52) U.S. Cl. CPC B23K 9/16; B23K 9/285

(57) ABSTRACT

A welding device, having a body configured to route power, a first inlet and a first outlet formed on the body, the first inlet configured to receive a shielding gas, a first channel extending through the body and connecting the first inlet and the first outlet, a second inlet and a second outlet formed on the body, the second inlet configured to receive a coolant, a second channel extending through the body and connecting the second inlet with the second outlet, the second channel having a convoluted portion comprising a plurality of segments configured to increase a proportion of the second channel relative to the body.

### CLAIM OF PRIORITY

This application claims priority to U.S. Provisional Pat. Application Number 63/270,167 filed Oct. 21, 2021, the disclosure of which is incorporated by reference herein.

### TECHNICAL FIELD

The present disclosure relates generally to welding devices for welding machines and, more particularly, to torch blocks for arc welding machines.

### BACKGROUND

Welding generally involves applying heat hot enough to melt two metals together. Numerous welding techniques are well known in the art, including arc welding techniques which rely on supplying an electric current to an electrode for generating heat through an electric arc. The electrode couples to a torch block which includes separate conduits for circulating a coolant and for dispersing a shielding gas. The coolant helps protect against the intense heat from the electric arc, and the shielding gas helps protect a weld area from oxygen, moisture, gases, and/or other atmospheric conditions that may contaminate the weld area and reduce the quality of the weld. Well known arc welding techniques include at least Tungsten Inert Gas (TIG), and Metal Inert Gas (MIG).

It remains desirable to develop further improvements and advancements in torch block design and fabrication, to overcome shortcomings of known techniques, and to provide additional advantages.

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

### SUMMARY OF INVENTION

One embodiment of the present disclosure provides a welding device, having a body configured to route power, a first inlet and a first outlet formed on the body, the first inlet configured to receive a shielding gas, a first channel extending through the body and connecting the first inlet and the first outlet, a second inlet and a second outlet formed on the body, the second inlet configured to receive a coolant, a second channel extending through the body and connecting the second inlet with the second outlet, the second channel having a convoluted portion comprising a plurality of segments configured to increase a proportion of the second channel relative to the body.

Another embodiment of the present disclosure provides a method of manufacturing a welding device using a 3D printer, including printing successive layers of a material to form a three-dimensional body having a first inlet, a first outlet, a second inlet, and a second outlet, the plurality of layers having a first subset of adjoining layers each having respective first spaces devoid of the material, for defining a first channel extending through the body for pathing a shielding gas, the first channel connecting the first inlet and the first outlet, and a second subset of adjoining layers each having respective second spaces devoid of the material, for defining a second channel for pathing a coolant, the second channel extending through the body and connecting the second inlet and the second outlet, the second channel having a convoluted portion comprising a plurality of segments configured to increase a proportion of the second channel relative to the body.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

The invention now will be described more fully hereinafter with reference to the accompanying drawings, in which some, but not, all embodiments of the invention are shown. Indeed, this invention may be embodied in many different forms and should not be construed as limited to the embodiments set forth herein; rather, these embodiments are provided so that this disclosure will satisfy applicable legal requirements.

FIG. 1A is a perspective view of a brass prior art torch block, for use with an arc welding device;

FIG. 1B is a front elevation view of the prior art troch block illustrated in FIG. 1A;

FIG. 1C is a rear elevation view of the prior art torch block illustrated in FIG. 1A;

FIG. 1D is a side elevation sectional view of the prior art torch block illustrated in FIG. 1A, in accordance with the sectional lines illustrated in FIG. 1C;

FIG. 2 is a perspective sectional view of the prior art torch block illustrated in FIG. 1A, provided adjacent an arc welding device;

FIG. 3A is a perspective view of an embodiment of a welding device manufactured in accordance with the disclosure herein, specifically, the welding device is a copper torch block for use with an arc welding device, manufactured using a 3D-printer configured to print with copper;

FIG. 3B is a transparent perspective view of the torch block illustrated in FIG. 3A;

FIG. 4A is an elevation view of the torch block illustrated in FIG. 3A;

FIG. 4B is sectional view of the torch block illustrated in FIG. 3A, in accordance with the sectional lines illustrated in FIG. 4A; and

FIG. 4C is an enlarged sectional view of the gas outlet illustrated in FIG. 4B.

Repeat use of reference characters in the present specification and drawings is intended to represent same or analogous features or elements of the invention according to the disclosure.

### DESCRIPTION OF THE PREFERRED EMBODIMENTS

Reference will now be made to presently preferred embodiments of the invention, one or more examples of which are illustrated in the accompanying drawings. Each example is provided by way of explanation, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, terms referring to a direction or a position relative to the orientation of the welding device, such as but not limited to “vertical,” “horizontal,” “upper,” “lower,” “above,” or “below,” refer to directions and relative positions with respect to the welding device’s orientation in its normal intended operation, as indicated in the Figures herein. Thus, for instance, the terms “vertical” and “upper” refer to the vertical direction and relative upper position in the perspectives of the Figures and should be understood in that context, even with respect to a welding device that may be disposed in a different orientation.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

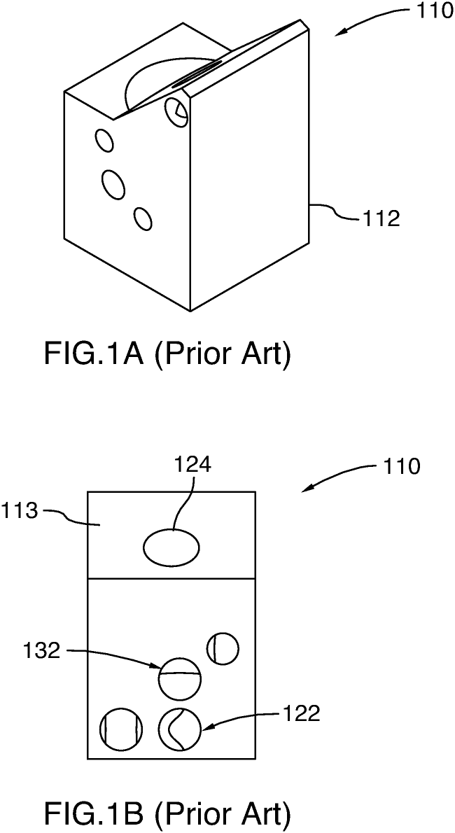

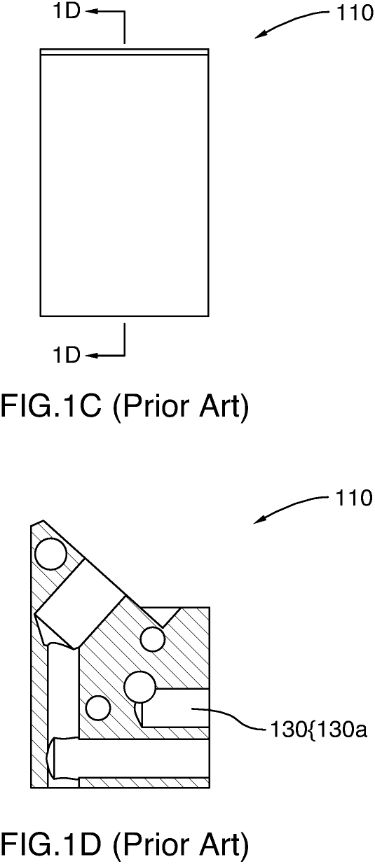

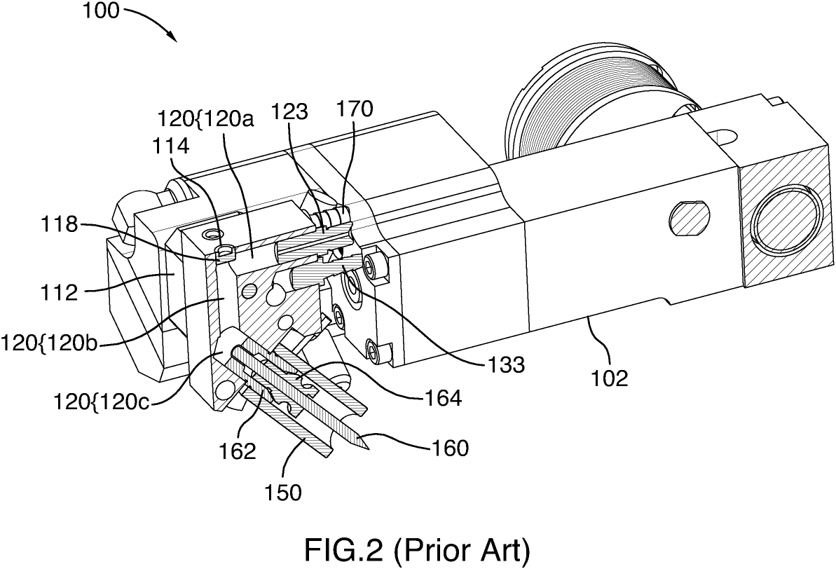

Referring now to the figures, a prior art brass torch block 110 is shown in FIGS. 1A through 1D. The torch block 110 stands approximately 2″ in height with a predominately cube shaped body 112 including an angled section 113. The torch block 110 mounts to a welding arm 102, as part of an assembly for an arc welding tool 100, further illustrated in FIG. 2. The torch block 110 includes an argon gas channel 120 extending through the body 112, for pathing argon from an argon inlet 122 to an argon outlet 124. The torch block 110 receives the argon through a solder fitting 123 coupled to the argon inlet 122, for output to a diffuser cup 150 coupled to an outer torch collet 162 connected to the argon outlet 124. The diffuser cup 150 disburses the argon about the tungsten electrode 160 to generate a protective shield, insulating a weld area from oxygen, moisture, gases, and/or other atmospheric conditions that may contaminate the weld area and/or reduce a quality of the weld during operating of the arc welding tool 100.

The torch block 110 further includes a coolant channel 130 extending through the body 112, for pathing a coolant such as water, from a coolant inlet 132 to a coolant outlet 134. Other examples of coolant include demineralized or deionized water, including adding additives to the water. The torch block 110 receives the coolant through a solder fitting 133 coupled to the coolant inlet 132, for transmission through the body 112 to the coolant outlet 134. The coolant counteracts temperature increases in the torch block 110 arising from the intense heat generated by the tungsten electrode 160 during operation of the arc welding device 100. The tungsten electrode 160 is held by an inner torch collet 164 coupled to the outer torch collet 162. The tungsten electrode 160 outputs an electrical arc based on an electrical current supplied by an electrically insulated wire (not illustrated) electrically coupled to the tungsten electrode 160. The electrically insulated wire is further coupled to an input connection 170 configured to connect with an external power supply.

Machining techniques are used to create the channels 120 and 130 through the body 112 of the torch block 110. Machining is generally understood to encompass subtractive manufacturing techniques that remove material from an object. In this manner, machining tools penetrate an exterior surface of the torch block to bore cavities through the body 112 by removing material from the torch block 110. For example, machining may include piercing an exterior of the torch block 110 to bore internal cavities into the body 112, including repeating this process as necessary to define a channel comprising a plurality of cavities. As illustrated in FIG. 2, the argon channel 120 for pathing argon between the inlet 122 and the outlet 124 comprises three straight channel segments 120a, 120b, and 120c, formed using machining techniques. A machining tool may pierce an exterior surface of the torch block 110, to form the argon inlet 122, and continue boring a cavity partially into the body 112, defining a straight channel segment 120a. This process can be similarly repeated to fabricate straight channel segments 120b and 120c. The machining tool pierces an exterior area 114 of the torch block 110 to bore a cavity partially into the body 112, defining a straight channel segment 120b that intersects at a 90 degree angle with the straight channel segment 120a. The machining tool further pierces an exterior of the torch block 110 to form the argon outlet 124, and continues boring a cavity partially into the body 112, defining a straight channel segment 120c that intersects at an angle with the straight channel segment 120b. The channel segments 120a, 120b, and 120c co-operatively form the argon channel 120 extending through the body 112 of the torch block 110 between the gas inlet 122 and the gas outlet 124. A sealing element 180 is further fitted into a portion of the straight channel segment 120b, to seal the argon channel 120 from the exterior area 114.

As illustrated in FIG. 1D, the coolant channel 130 for pathing a coolant between the coolant inlet 132 and the coolant outlet 134 comprises straight channel segments, such as straight channel segment 130a, formed using machining techniques. A machining tool may pierce an exterior of the torch block 110 to form the coolant inlet 132, and further continues boring a cavity partially into the body 112, defining a straight channel segment 130a. Similarly, the machining tool pierces an exterior of the torch block 110 to form the coolant outlet 134, and further continues boring a cavity as elsewhere needed to form straight, interconnecting channel segments. Thereby, a plurality of straight channel segments co-operatively form the coolant channel 130 extending through the body 112 of the torch block 110, between the coolant inlet 132 and the coolant outlet 134. The ability of the coolant to counteract the heat generated by the electrode 150 and the electric arc is predicated in part on the size and pathing of the coolant channel 130. A relatively longer channel for example, may provide coolant to a greater proportion of the torch block. A relatively larger channel circumference for example, may allow for a greater volume of coolant to flow through the torch block but with a reduced ratio of coolant channel surface area to torch block volume.

Machined fabrications are time consuming, and thus costly, and are further limited in their ability to bore cavities. For example, machining techniques are generally limited to boring straight or predominately straight cavities, and are thus limited in fabricating channels with curves, arcs, and bends. The need for machining tools to enter into the interior of the torch block from an exterior surface further limits the number of options for cavities. Every new bore and cavity quickly restricts further design options for fabricating channels. Consequently, every new bore created from an exterior of the torch block reduces the number of remaining options to path a channel through a torch block. This limits machining techniques to fabricating channels with relatively simple geometries that may path through a limited proportion of the torch block, or path within limited proximity to heat sources. Larger forms factors are thus required to provide an adequate volume of raw material to compensate for limitations inherent to machining. The need to isolate the shielding gas and coolant channels from intersecting further compounds machined fabrications and limits the number of options for boring cavities throughout the torch block. For example, the gas channel inherently paths into the gas outlet, restricting options for boring a coolant channel in close proximity to the gas outlet, an area which experiences significant heat exposure from the electrode.

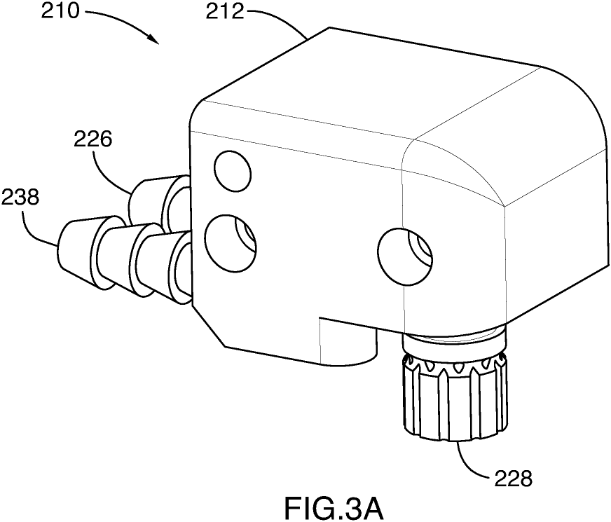

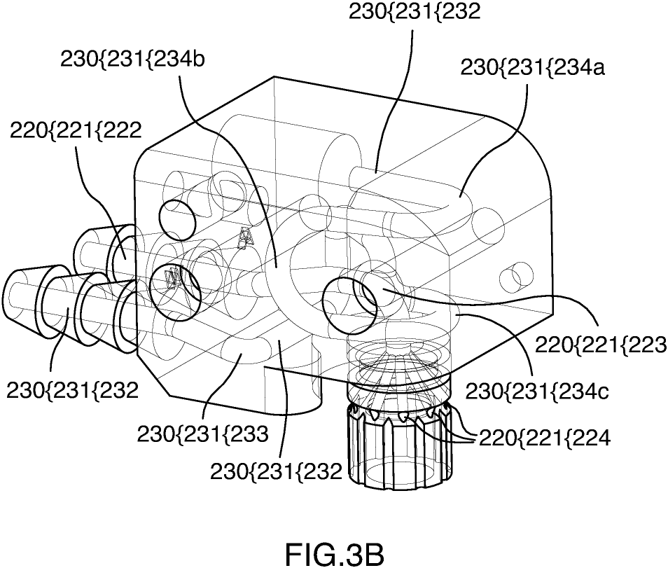

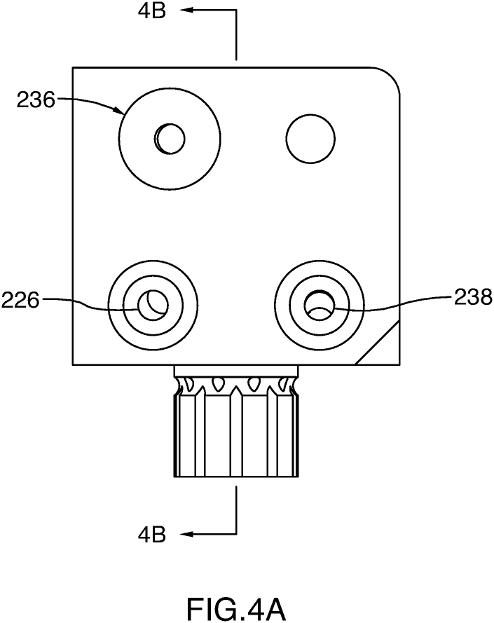

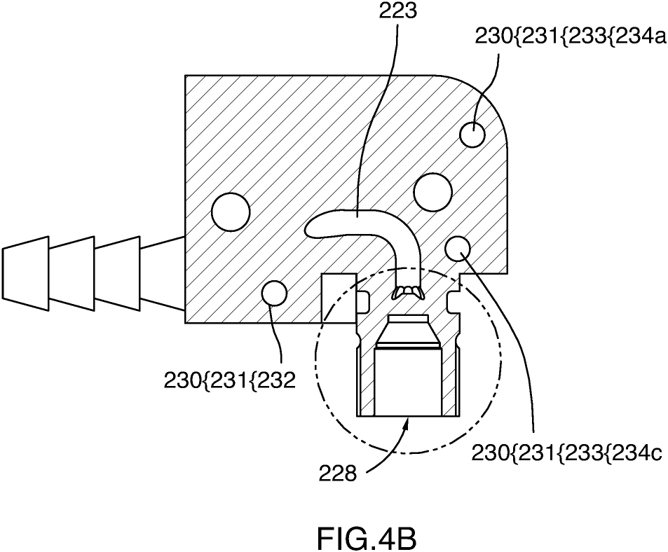

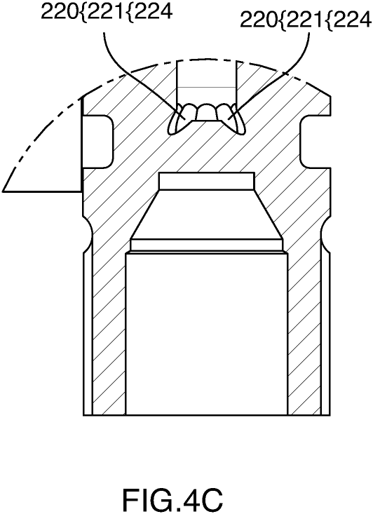

The welding device and method of manufacture disclosed herein generally relates to a torch block for a welding device, fabricated using additive manufacturing techniques. In particular, the welding device 210 illustrated in FIGS. 3A, 3B, 4A, 4B, and 4C is a conductive copper torch block 210 for use with an arc welding device, fabricated using a 3D-printer configured to print with copper. The 3D printer forms the torch block 210 through printing two-dimensional layers of copper, successively stacked to form a three-dimensional structure. Each two-dimensional layer includes copper and may include open space devoid of any material. Open spaces in adjoining layers co-operatively define three dimensional cavities within the torch block 210. Thus, additive manufacturing eliminates the need to bore from an exterior surface to define internal channels in the torch block 210, resulting in a smaller form factors relative to machining fabrications. In an embodiment, a subset of adjoining layers includes respective open spaces for defining a channel. In an embodiment, a first subset of adjoining layers includes respective first spaces devoid of any material for defining a shielding gas channel; and, a second subset of adjoining layers includes respective second spaces devoid of any material for defining a coolant channel. In such embodiments, some layers may include both first spaces and second spaces.

Additive manufacturing and 3D-printing techniques can fabricate channels having complex pathways and/or segments that machining techniques cannot fabricate. For example, 3D-printing can produce internal channels that include winding segments, arcuate segments, U-shaped segments, twisting segments, helical segments, spiral segments, serpentine segments, undulating segments, and other complex or convoluted segments. Advantageously, 3D-printing can fabricate structures comprising such segments to form coolant channels having elaborate, tortuous sections for convoluting the coolant channel, enhancing cooling capabilities. Channel convolutions may be formed throughout the torch block, increasing the proportion of coolant channel to torch block. Channel convolutions may also be localized to a particular area, such as adjacent a heat source to provide greater cooling capacity to heat exposed areas. Further yet, channel convolutions may be formed to path around obstructions or other internal structures in the torch block. For example, the coolant channel may include a channel convolution comprising a helical or spiral segment encircling a shielding gas channel in an area adjacent to an electrode, providing greater cooling capabilities than otherwise possible with machining techniques. Accordingly, advantages of a device and method of manufacture disclosed herein may include, but are not limited to, smaller form factor, faster fabrication times, conducting power through the torch block body rather than an electrically insulated line, and enhanced cooling capabilities. Smaller form factors may provide the further advantage of welding joints that may otherwise be inaccessible to larger form factor torch blocks fabricated using machining techniques.

FIGS. 3A, 3B, 4A, 4B, and 4C illustrate an embodiment of a welding device 210, manufactured in accordance with the disclosure herein. In particular, the welding device 210 is a copper torch block for use with an arc welding device, manufactured using a 3D-printer configured to print with copper. The torch block stands approximately ⅞″ tall and comprises a conductive copper body 212, configured to route power directly through the body 212 to an electrode (not illustrated) connected to the body 212. A conductive torch block 210 eliminates the need to route power to an electrode through an insulated wire. Those skilled in the art will appreciate however, that embodiments disclosed herein include a welding device formed to include capacity for an insulated wire to route power to an electrode.

The 3D printer forms the torch block 210 to include a shielding gas channel 220 having a relatively direct path between a gas inlet 226 and a gas outlet 228. The shielding gas channel 220 paths a shielding gas received at the gas inlet 226, to a diffuser cup coupled to the gas outlet 228. Standard shielding gases known in the art, such as argon, are suitable for transmission through the conductive torch block 210. The gas inlet 226 and the gas outlet 228 may be fabricated as open ports, allowing for connections to other components, through welding, soldering, or other connecting means. The gas inlet 226 and gas outlet 228 may also be fabricated as components including for example solder fittings and torch collets. Forming the inlet and outlet may also be left for a final step of manufacturing, after the torch block has been manufactured with an internal channel for pathing the shielding gas. In the illustrative embodiments, the gas inlet 226 comprises a solder fitting, and the gas outlet 228 comprises a hollow cylinder for coupling with a diffuser cup. The shielding gas channel 220 includes a plurality of segments 221 including straight segments 222, arcuate segments 223, and splayed segments 224. The splayed segments 224 disburse the shielding gas about gas outlet 228, advantageously improving gas flow and allowing for smaller form factor diffuser cups. In an embodiment, the diffuser cup is less than about 1″ in diameter. In an embodiment, the diffuser cup is about a ¼″ in diameter.

The 3D printer further forms the torch block 210 to include a coolant channel 230 having a convoluted path between a coolant inlet 236 and a coolant outlet 238, for pathing a coolant, such as water, through the torch block 210. The coolant inlet 236 and the coolant outlet 238 may be fabricated as open ports, allowing for connections to other components, through welding, soldering, or other connecting means. The coolant inlet 236 and coolant outlet 238 may also be fabricated as components including solder fittings, or may be left for a final step of manufacturing, after the torch block has been manufactured with a convoluted internal channel for pathing the coolant gas. In the illustrative embodiments, the coolant outlet 238 comprises an open port having a diameter relatively larger than the coolant channel segments 231, and the coolant inlet 236 comprises a solder fitting. The coolant channel 230 includes a plurality of segments 231 including straight segments 232, and arcuate segments 233 including U-shaped segments 234a, 234b, and 234c. The various segments convolute the coolant channel 230 throughout the torch block body 212, increasing a proportion of the coolant channel 230 relative to the torch block 210. For example, convoluting a coolant channel throughout the torch block can increase a ratio of the surface area of the coolant channel to the volume of the torch block. The coolant channel 230 is further fabricated to convolute a portion of the coolant channel 230 proximal to the gas outlet 228, to provide greater cooling capacity closer to the electrode, the primary heat source. The convoluted portion includes three U-shaped segments: 234a, 234b, and 234c, for convoluting the coolant channel in proximity of the gas outlet 238 and around the gas channel 220. In an embodiment, the coolant channel includes a plurality of segments for convoluting the coolant channel in an area adjacent a heat source. The segments may include straight segments and arcuate segments. The plurality of arcuate segments may form a more complex segment, such as a helical, spiral, or serpentine segment.

Example dimensions of a conductive copper torch block manufactured in accordance with the disclosure herein include a torch block having widths ranging from ⅜″ to 1-½″, depth ranging from ⅜″ to 1-½″, and height ranging from ½″ to 1-½″. The small dimensions are application specific and allow for a torch block that does not inhibit physical access to weld areas with limited access or other obstructions that may limit welding when otherwise using larger torch blocks. The torch block may also be manufactured with other physical dimensions.

While the foregoing disclosure primarily describes a 3D-printed copper torch block for arc welding devices, those skilled in the art will appreciate that other welding devices for use in arc welding and other welding techniques may be manufactured without departing from the disclosure herein. Furthermore, the foregoing is not limited to copper torch blocks. For example, 3D-printers are capable of printing with other conductive materials suitable for a conductive torch block, such as brass.

In the preceding description, for purposes of explanation, numerous details are set forth in order to provide a thorough understanding of the embodiments. However, it will be apparent to one skilled in the art that these specific details are not required. In other instances, well-known electrical structures and circuits may be shown in block diagram form in order not to obscure the understanding. For example, specific details are not provided as to whether the embodiments described herein are implemented as a software routine, hardware circuit, firmware, or a combination thereof. The scope of the claims should not be limited by the particular embodiments set forth herein, but should be construed in a manner consistent with the specification as a whole.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

1. A welding device, comprising:
a body configured to route power;
a first inlet and a first outlet formed on the body, the first inlet configured to receive a shielding gas;
a first channel extending through the body and connecting the first inlet and the first outlet;
a second inlet and a second outlet formed on the body, the second inlet configured to receive a coolant;
a second channel extending through the body and connecting the second inlet with the second outlet, the second channel having a convoluted portion comprising a plurality of segments configured to increase a proportion of the second channel relative to the body.

2. The welding device of claim 1, wherein the convoluted portion is proximal to the first outlet.

3. The welding device of claim 1, wherein the plurality of segments includes a plurality of arcuate segments.

4. The welding device of claim 3, wherein the plurality of arcuate segments encircles a portion of the first channel adjacent the first outlet.

5. The welding device of claim 4, wherein the plurality of arcuate segments forms a serpentine segment.

6. The welding device of claim 3, wherein the plurality of arcuate segments forms a spiral segment or a helical segment.

7. The welding device of claim 1, wherein the second channel includes a plurality of the convoluted portion, configured to maximize the proportion of the second channel relative to the body.

8. The welding device of claim 7, wherein the first outlet includes a plurality of splayed segments connected to the first channel, configured to disburse the shielding gas received by the first outlet.

9. The welding device of claim 8, wherein the first outlet is configured for coupling with a diffuser cup.

10. The welding device of claim 9, wherein the first inlet comprises a first solder fitting and the second inlet comprises a second solder fitting.

11. The welding device of claim 10, wherein the first outlet further comprises a torch collet configured for holding an electrode.

12. The welding device of claim 11, wherein the body comprises a conductive material configured to route the power directly through the body.

13. The welding device of claim 12, wherein the conductive material is copper.

14. The welding device of claim 1, further comprising:
an input port and an output port formed on the body, and
a third channel extending through the body for housing an electrically insulated power line, the third channel connecting the input port and the output port.

15. The welding device of claim 1 manufactured using an additive manufacturing process.

16. A method of manufacturing a welding device using a 3D printer, comprising:
printing successive layers of a material to form a three-dimensional body having a first inlet, a first outlet, a second inlet, and a second outlet, the plurality of layers including:
a first subset of adjoining layers each having respective first spaces devoid of the material, for defining a first channel extending through the body for pathing a shielding gas, the first channel connecting the first inlet and the first outlet, and
a second subset of adjoining layers each having respective second spaces devoid of the material, for defining a second channel for pathing a coolant, the second channel extending through the body and connecting the second inlet and the second outlet, the second channel having a convoluted portion comprising a plurality of segments configured to increase a proportion of the second channel relative to the body.

17. The method of claim 16, wherein the material is a conductive material.

18. The method of claim 17, wherein printing the successive layers of the material to form the three-dimensional body further comprises forming an input port and an output port on the body, the plurality of layers further comprising:
a third subset of adjoining layers each having respective third spaces for defining a third channel extending through the body between the input port and the output port, the third channel configured for housing an electrically insulated power line.
